(19) United States
(12) Patent Application Publication
(10) Pub. No.: US 2015/0354244 A1
(43) Pub. Date: Dec. 10, 2015

(54) FLEXIBLE SHADOW-GENERATING WIND-ENERGY DEVICE INTENDED TO PROVIDE SOLAR PROTECTION

(71) Applicant: Jesús Omar FERNÁNDEZ GONZÁLEZ, Culiacán, Sinaloa (MX)

(72) Inventor: Jesús Omar FERNÁNDEZ GONZÁLEZ, Culiacán, Sinaloa (MX)

(21) Appl. No.: 14/760,899

(22) PCT Filed: Jan. 14, 2014
(86) PCT No.: PCT/MX2014/000006

§ 371 Date: Jul. 14, 2015

(30) Foreign Application Priority Data
Jan. 16, 2013 (MX) MX/A/2013/001004

(51) Int. Cl. E04H 15/58; E04H 15/62; B64C 31/06; E04H 15/20

(52) U.S. Cl. CPC E04H 15/58; E04H 15/20; E04H 15/62; B64C 31/06

(57) ABSTRACT

A flexible shadow-generating wind-energy device intended to provide solar protection is provided, the device using the kinetic energy of the wind in order to be supported in the air and project a shadow. The device is formed by a panel or group of panels and one or more beams, which together define a bow edge, a stern edge and sides. The device has flaps that provide stability and are used to anchor same to the ground. The device operates as follows: the panel or panels together with the flaps and the beams surround a moving air mass; the aerodynamic forces generated are sufficiently strong to support the device in the air; the device is maintained anchored to the ground; with the device anchored to the ground, it can be maintained at a pre-determined height and project a shadow on a surface below.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention, as stated in the title of this specification description document, refers to a flexible shadow-generating wind-energy device intended to provide solar protection, which has qualities that enable it to harness kinetic energy of the wind to stay in the air and cast a shade. It is suitable for any place during the day in windy conditions.

This device is designed and equipped to help you to take advantage of the kinetic energy of the wind and to remain sustained in the air at a certain height, this being possible because of a balance of forces between the aerodynamic forces and counterbalances that keep the device attached to the ground. The device has elements that have the ability to filter or block sunlight and cast a shade on the ground. Hence, the flexible shadow-generating wind-energy device intended to provide solar protection works when the wind impacts on the surface of the device. The resulting aerodynamic forces allow the device to be sustained in the air, and by counterbalances or anchoring elements the device is kept at a certain height, which allows to cast a shade on an underlying surface.

The present invention refers to a shadow-generating wind-energy device, flexible, foldable and portable, used for sun protection on beaches, which is easily adaptable for use on the beach as a shade generating unit, which is very lightweight, compact and easy to handle.

The purpose of this invention is to provide a shadow-generating device, which is lightweight, foldable, making it easy to handle and transportable, enabling to be movable and/or easily adjustable in different positions depending on the direction and wind intensity.

2. Description of Related Art Including Information Disclosed Under 37 CFR 1.97 and 37 CFR 1.98.

There are many well-known types of shadow-generating devices based on structures that support a membrane-type panel that filters or blocks the incidental sunlight. They are partially composed by a rigid structure, complemented by a flexible membrane canvas-like. Most of these are used in order to protect against undesirable weather conditions, most commonly the sun. In this regard, we may mention various types of devices, such as umbrellas, awnings, canopies, camping tents, and parasols, among others. These devices are mainly made of a structure that is fully or partially covered by a panel or membrane that filters or blocks the sunlight and casts a shade on the ground. Related Patents such as; U.S. Pat. No. 261,407 of Moss, U.S. Pat. No. 4,332,266 of Wageley, U.S. Pat. No. 4,750,508 of Tatoian, U.S. Pat. No. 5,927,311 of Jager, U.S. Pat. No. 4,343,322 of Fiddler, all these devices have the feature of using a conventional structure made mostly of rigid elements. Some of them have the quality of being foldable and portable as far as their weight and complexity allow it. There are other patents where their inventiveness has a more practical approach, employing flexible, foldable and lightweight structures. Such patents are; U.S. Pat. No. 4,719,934 of Mydans, U.S. Pat. No. 3,394,720 of Moss, U.S. Pat. No. US D649 616 S of Bandini. These patents despite using flexible structural elements, they are still limited by having several solid structural elements meaning a laborious activity when using. All these devices have the disadvantage of being made of a large number of elements, which are generally dependent on each other for proper operation of the shade-device; in addition, its structure is almost entirely made of solid, rigid elements, which tend to be heavy and complex. These inventions by lacking aerodynamic advantages, its use on beaches becomes complicated, as they are vulnerable to strong gusts of wind, risking of being destroyed by them or at least becomes complicated to use.

### BRIEF SUMMARY OF THE INVENTION

The device of the invention presents a new structural technique to effectively adapt to climatic conditions existing on the beach during a sunny day, through its flexible, lightweight and adjustable structure that uses wind kinetic energy.

More specifically, the device is provided with a panel or set of panels that can be made of one or more surfaces or be shaped by joining a number of beams defining a prow or fore edge, an aft edge and side or lateral ends.

The device has fins adjacent to each lateral end panel, and optionally a fin at the rear end (aft), which may optionally be attached to the aft edge of the panel.

Preferably each panel is made of surfaces able to filter and/or block the sunlight, so that the incident solar rays on the receiving surface of the panel are filtered/blocked and cast a shade. Preferably the fins are mostly constituted by the same kind of material used in the panel or panels' elements, but other materials may also be used.

Fins in conjunction with the panel or panels and beams receive a moving air mass, which generates a lifting force.

Fins' ends may optionally have containing elements that enable to add substances that generate weight to balance the aerodynamic forces produced by the device. But preferably each fin has one or more fasteners that connect to anchor bodies using connection elements.

Fins' fasteners can be connected to the anchor bodies using connection elements and separated at a certain distance from these. The connecting elements are preferably flexible, but may be rigid or semi-rigid.

The connecting elements may have a fixed length, but preferably a variable length, so that may allow to change conveniently the distance separating the device from the ground, to a height that is convenient for the user.

As for the beams, these may be of various shapes and types, for example, low weight rods. Another alternative are long tube shaped beams sealed at both ends in order to confine any kind of gas therein ensuring that the pressure inside the tube is equal to or greater than the existing atmospheric pressure at the place where is used the device. In this invention it is also possible to use flexible tube shaped beams open at one end and closed at the other end. The invention is not limited to these types of beams or possible combinations of types of beams.

Beams may be right over the fore edge and/or right over the stern edge of the panel or panels, or may extend beyond these borders. The axes of each beam may be parallel to the longitudinal axis or have an angle of incidence with this axis and/or a beam on the other(s).

Preferably, the beams of this device beams comprise semi-open chambers or tubular ducts closed at one end and open at the other end. These can be of different cross-section along its longitudinal axis.

Optionally the device can have multiple beams. Any of these beams can optionally have a fin and/or anchoring equipment, but preferably the device's external side beams must present at least one fin each.

When more than two beams, preferably the two beams that are at the ends are adjusted so that there is an angle of incidence between them, where the greatest separation between the beams is located in the fore edge and less separation between the beams located in the aft edge. Optionally beams may be parallel between themselves and/or with the longitudinal axis.

The device works properly with a panel, two beams and two fins, but may have any number of panels, beams and fins; however, different variations of this device can also be in one beam and two fins.

The device's semi-open beams inflate by the dynamic pressure produced by the wind striking the beams' open end, which is preferably located in the fore edge.

Preferably the operation of the device is as follows; the device has one or more flexible beams made by semi-open chambers, so that when air strikes the open end of the beam (beams), the pressure inside increases and pushes the beam's internal walls, inflating firmly such beams. This same airflow causes aerodynamic forces sufficiently strong to support the device in the air. To keep the device fixed at a certain height, weights are used to keep it anchored. Also connecting elements linking the device with anchoring bodies may be used. Once the device is anchored, it remains in the air at a certain height and casts a shade on the ground

The device may be made of lightweight and resistant materials. Optionally other materials may be used for certain components, such as plastic, metal, fibers, including ceramic and wood, however this invention is not limited to theses materials. All these material may be manufactured by an assembly technique.

### BRIEF DESCRIPTION OF THE DRAWINGS

This invention will be described with the following reference figures.

FIG. 1(A).—It displays a perspective view of the flexible shadow-generating wind-energy device and its components; panel, beams, fins, fasteners, connection elements and anchorage massive bodies.

FIG. 1(B).—It displays a device similar to FIG. 1 (A), without showing the rear fin (located in aft).

FIG. 2(A).—It displays a device very similar to that shown in FIG. 1 (A). Differenced by showing only three beams and more than a panel.

FIG. 2(B).—It displays a device similar to FIG. 2 (A), without showing the rear fin (located in aft).

FIG. 3(A).—It displays a device very similar to that shown in FIG. 1 (A). Differenced by showing only two beams and a panel.

FIG. 3(B).—It displays a device similar to FIG. 3 (A), without showing the rear fin (located in aft).

FIG. 4(A).—It displays a top view of the device illustrated in FIG. 1 (A), where the main axes are shown; longitudinal and lateral axis, plus the position of the three fins in the panel.

FIG. 4(B).—It displays a similar view of the device illustrated in FIG. 4 (A), without showing the rear fin.

FIG. 4(C).—It displays a similar view of the device illustrated in FIG. 4 (B), but this figure illustrates a variation of possible arrangements at the back (aft) of the device. These arrangements serve as fasteners.

FIG. 5.—It displays a device as shown in FIG. 2 (B), wherein reveals the orientation of the beams relative to the longitudinal axis of the device, and the edges of the beams that reach their respective fore and aft edges of the panel(s) and/or fins. Fins are also displayed to reveal the preferred geometry, including its fasteners.

FIG. 6.—It displays a device as depicted in FIG. 5, but the beams extend beyond the fore and aft edges of the panel(s).

FIG. 7.—It displays a device as shown in FIG. 3 (B), wherein reveals the orientation of the beams relative to the longitudinal axis of the device, and the edges of the beams that reach their respective fore and aft edges of the panel(s) and/or fins. Fins are also displayed to reveal the preferred geometry, including its fasteners.

FIG. 8.—It displays a device as depicted in FIG. 7, but the beams extend beyond the fore and aft edges of the panel(s).

FIG. 9.—It displays the fin's preferred shape where the fastening zone (fastening element) is preferably made of a material with greater mechanical strength than the fin's membrane or the same material used in fins but more strengthened.

FIG. 10.—It displays how the beams' opened edge has an angle of incidence regarding wind direction, which is preferably greater than zero degrees and less than 180 degrees. In general, this angle should allow air access into the beams.

FIG. 11.—It displays the device's front view in FIG. 1 (B). It shows the air access each beam has in its fore end.

FIGS. 12 and 13 Display a front view of FIGS. 2(B) y 3(B) respectively.

FIG. 14.—It displays a perspective view of the device in which it is seen that maintains an angle of attack regarding wind direction.

FIG. 15.—It displays the possible arrangement of containers at the end of each fin.

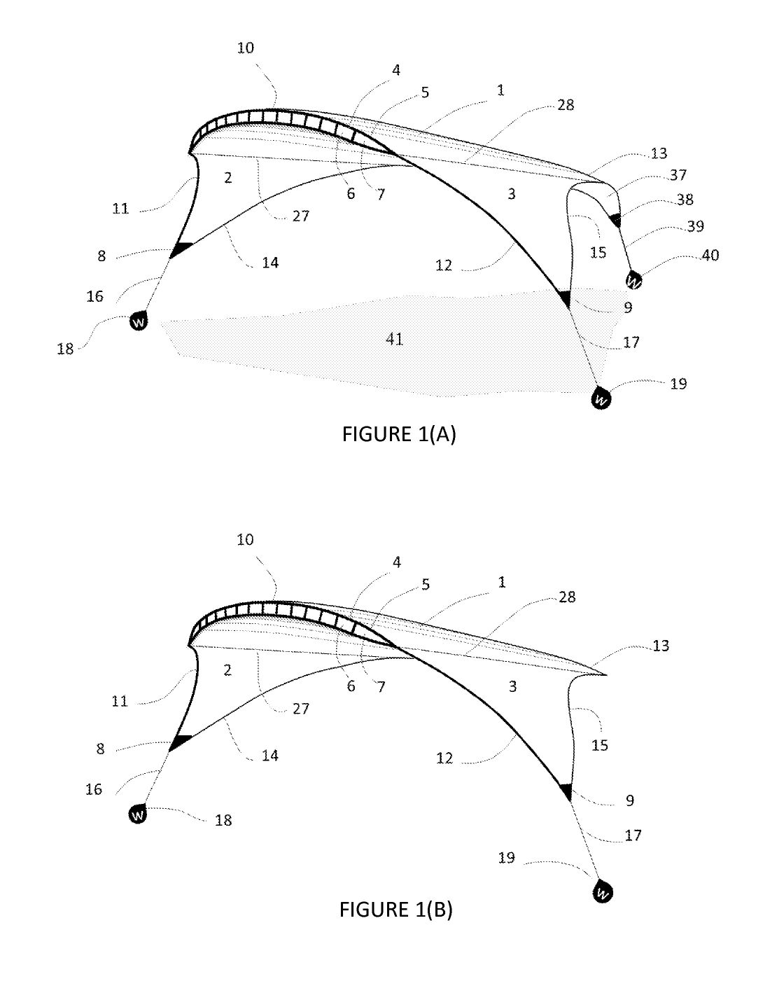

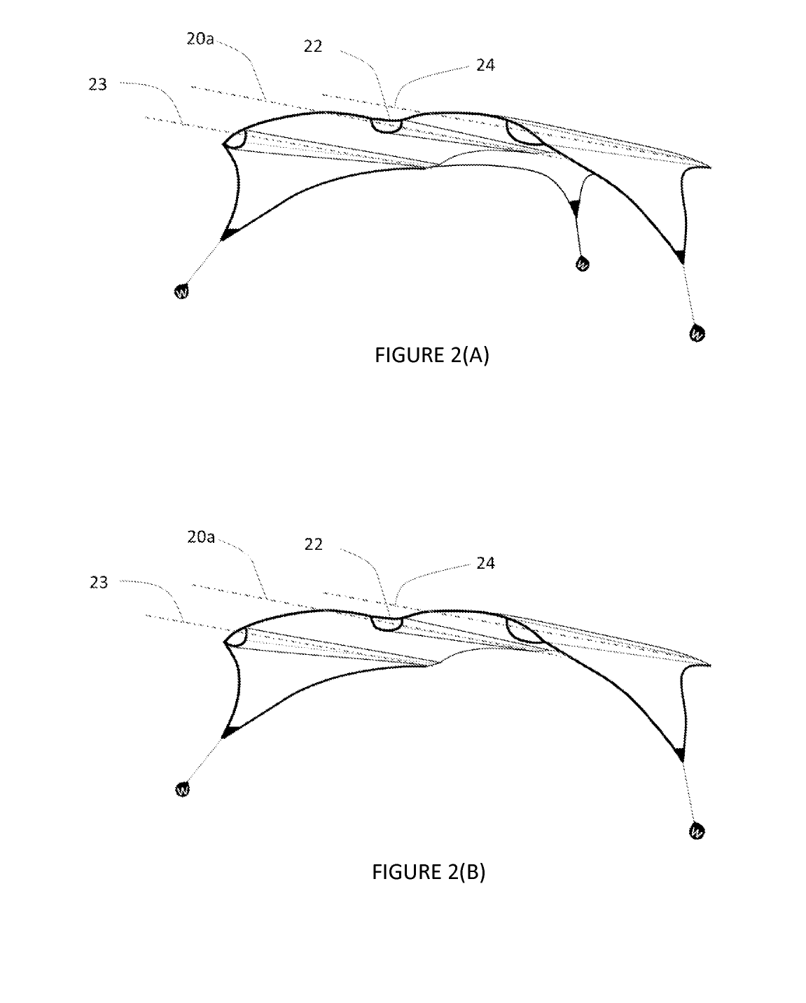

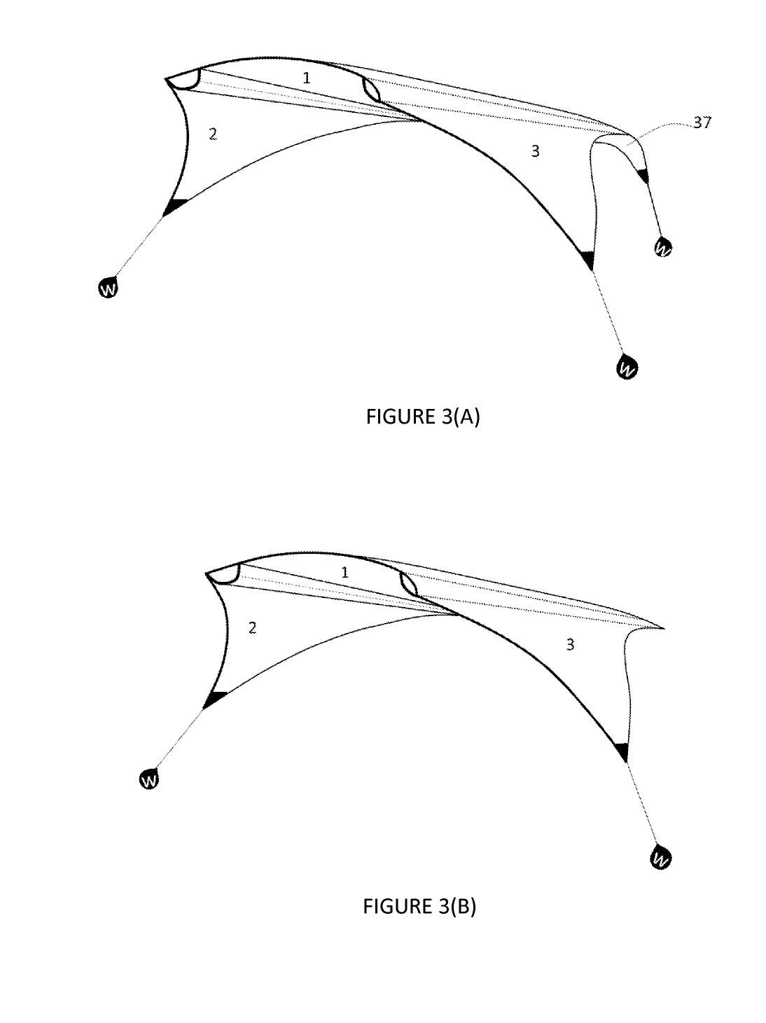

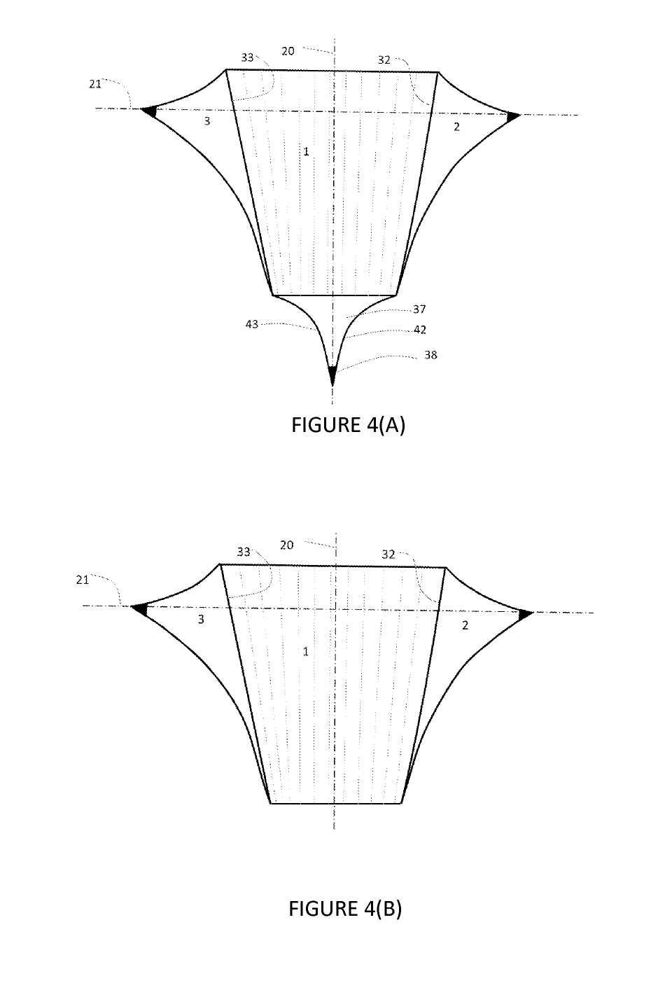

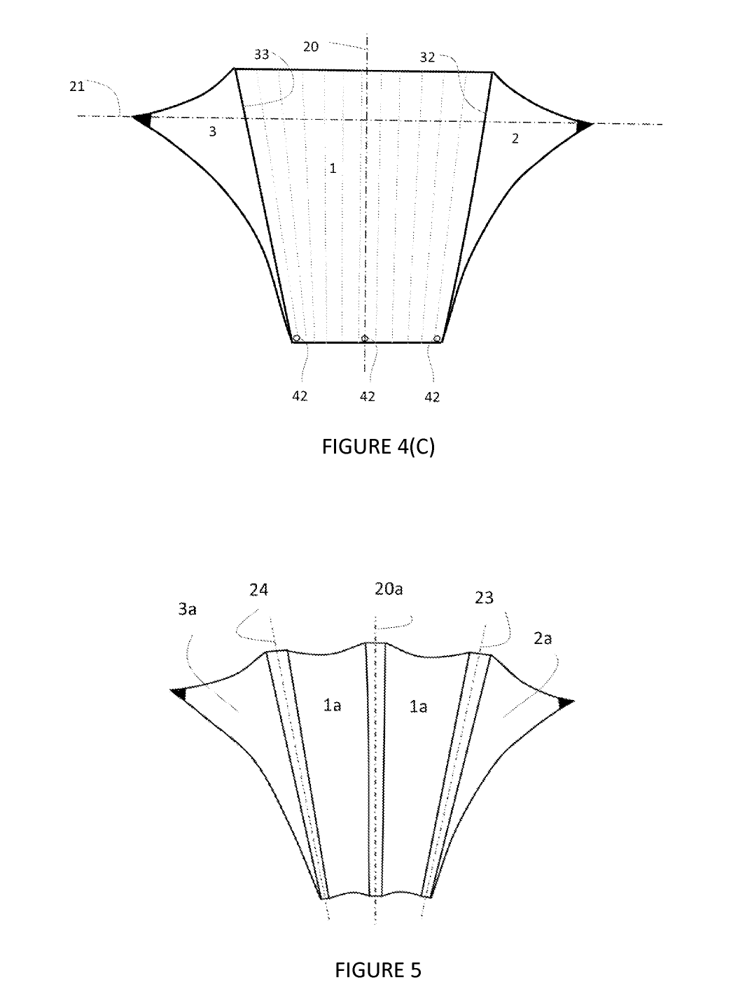

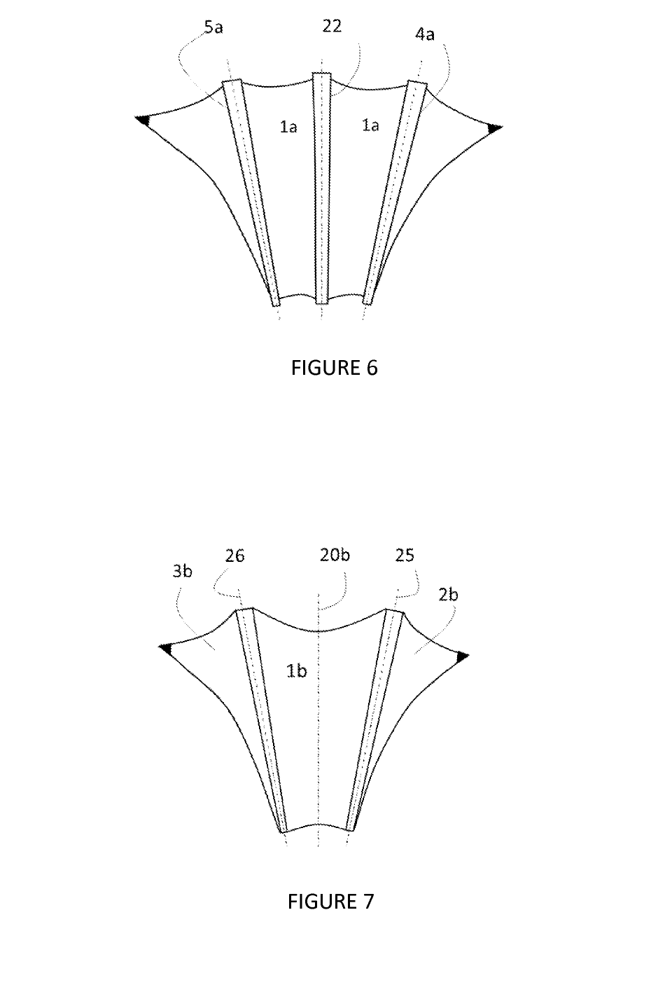

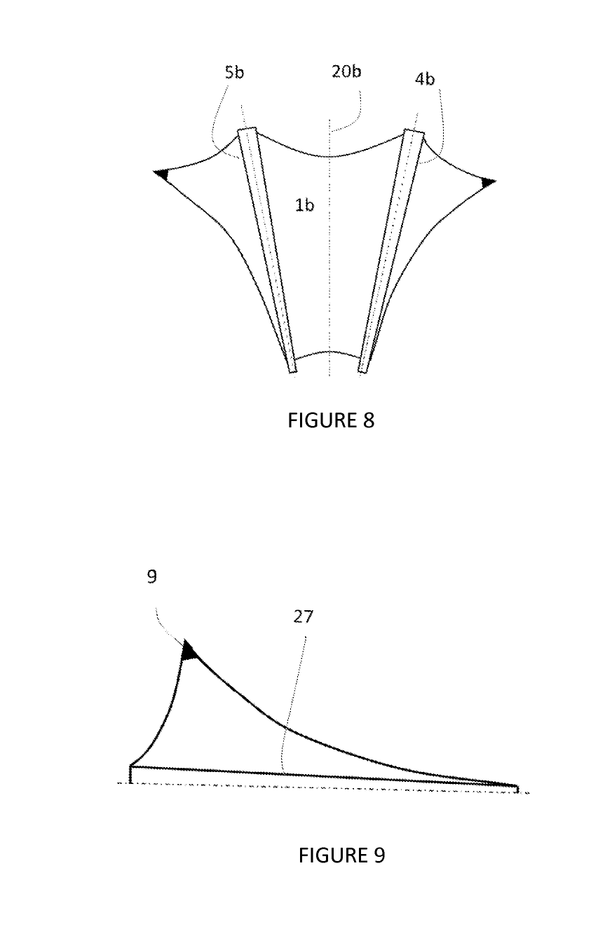

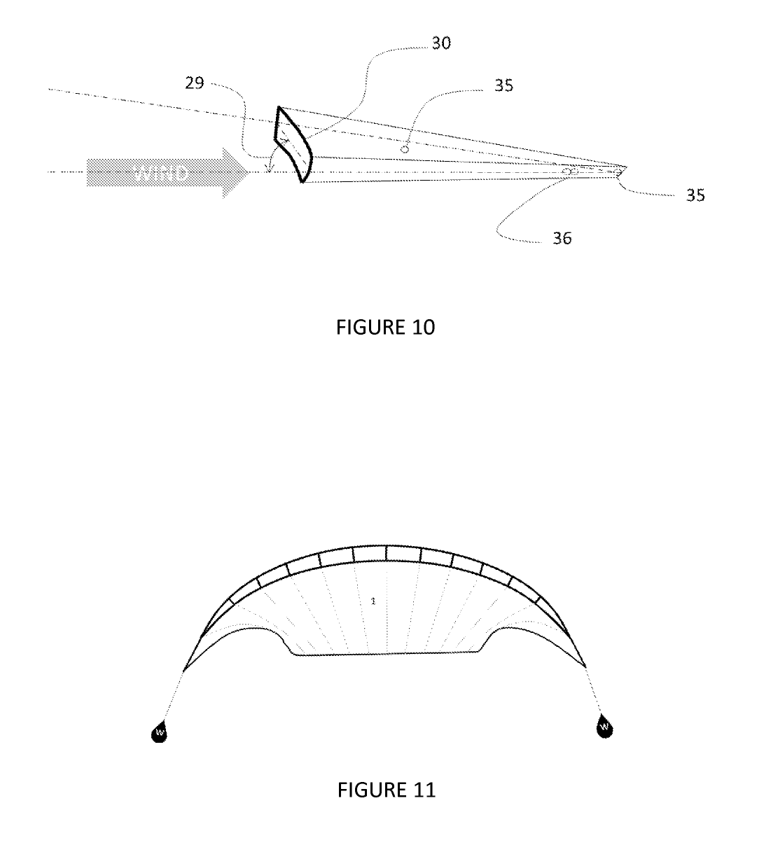

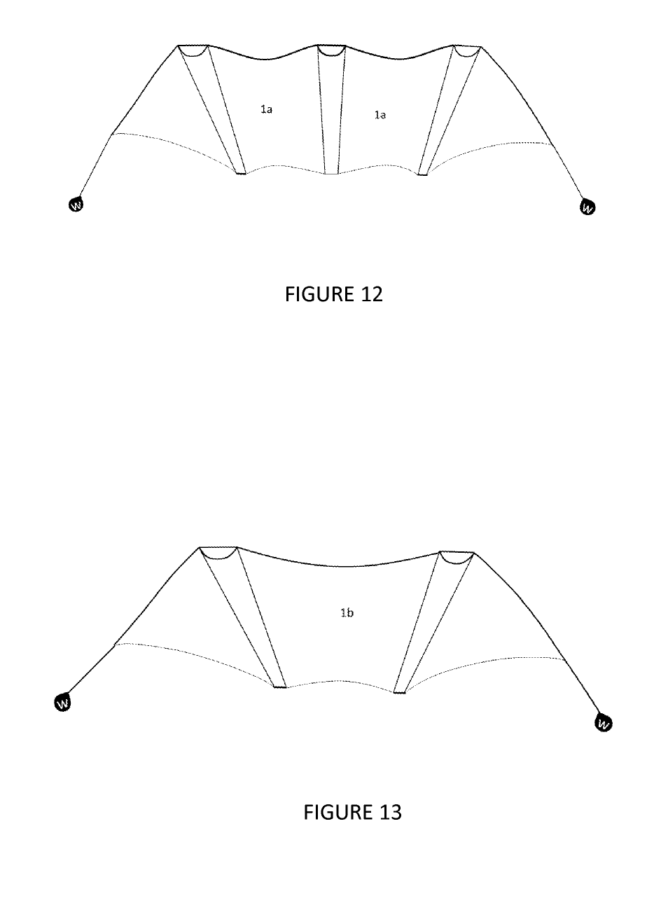

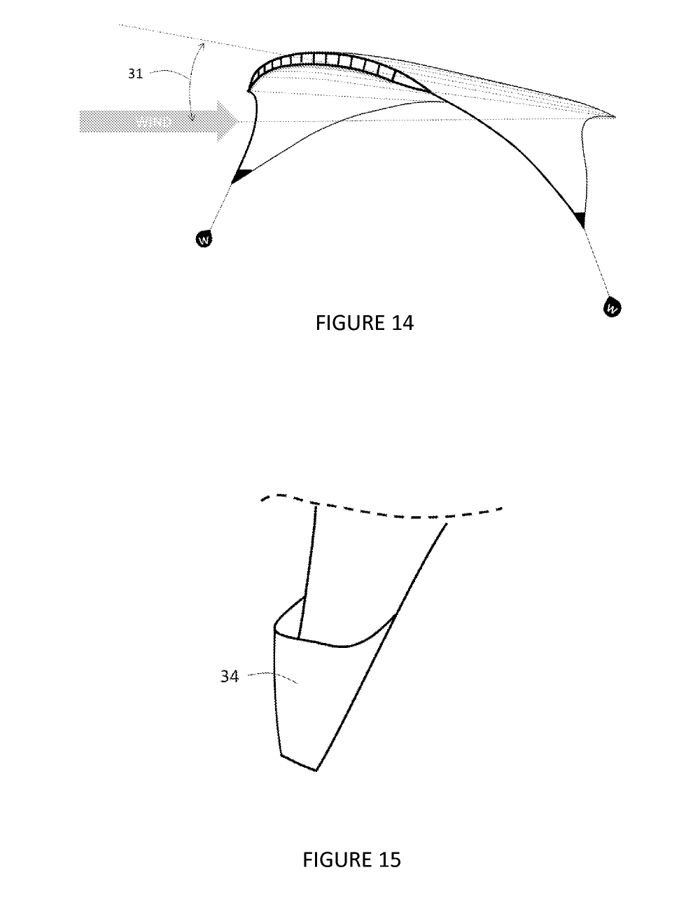

### DETAILED DESCRIPTION OF THE INVENTION

### Preferred Embodiment of the Invention

In the light of the aforementioned figures, one can see how the device is constituted partly by panel-type components (1) in a preferable trapezoidal shape configuration but also can be trapezoid, deltoid, rectangular, square, or other geometric shape that favors sustaining forces generation. Built with lightweight flexible, durable materials, having the quality of being able to filter sunlight, such as pigmented polyester textile, plastic, nylon, mixed, or other substance with similar characteristics. Such component shall be positioned so that the fore edge (10) represents the edge, which divides the airflow and sending one part on the top panel and the other airflow through the bottom of the panel. With the particularity that the fore (10) and aft (13) edges are strategically defined to provide stability and prevent the device from collapsing due to wind gusts. Also, the device is strategically provided with lateral edges (27) for each panel to remain adjacent to beams and/or fins.

Fins' shape, shall be preferably in triangle, trapezoid or other polygon shape, but generally may be of a type of geometry in order to provide stability to the device. Built with lightweight flexible materials, and durable textiles such as nylon, plastic, polyester, mixed or other material with similar characteristics. Lateral fins shall be positioned so that the fore edge (11,12) represents the edge, which divides the airflow and sending one part on the top part of the fin and the other airflow through the bottom of the fin. Fore (11, 12) and aft (14, 15) edges may be straight, or preferably curved describing an outward concavity, for added stability. Each fin is strategically provided with lateral edges (27,28) to remain adjacent to panel's lateral edges and/or beams. Optionally, a fin may be positioned in the aft edge of the device, in order to add more stability.

Beams; preferably semi-open tubular ducts (open on one end and closed at the other end) with its cross-sectional configuration preferably simple geometries such as circular, square, rectangular, trapezoidal or other polygonal shape so as to favor the proper functioning of the device, built with lightweight, flexible, durable materials, such as polyester textile, plastic, nylon, mixed or other materials with similar characteristics. Such component shall be positioned so the open end (6, 7) is in the fore edge, thereby dividing the airflow, sending a flow within the tubular beams and the other airflow on the outside thereof. With the particularity that the fore edges of the beams (30) can have an angle of attack (29) different to the angle of attack of the panel or panels (31).

The fastening elements (8, 9, 38) are located in the fins (2, 3, 37) and optionally serve as junction with the connection elements (16, 17, 39), which are attached to anchoring massive bodies (18, 19, 40) to anchor the device to the ground. Optionally the device's fins (2, 3, 37) may have containers (34), which can be filled with substances to perform the function of counter weight and anchoring.

No further description is required since any expert in the subject is able to understand the scope of this invention and the advantages derived therefrom.

1. Flexible shadow-generating wind-energy device intended to provide solar protection for use in places where there is a wind flow during day has or includes one or more panels, individual or collectively define the fore edge, the stern edge and lateral edges; at least one fin provided at or adjacent to each panel edge panel or side panels, where the fin is directly or indirectly joins to the connecting element which attaches to one or more massive bodies whose total mass is greater than the aerodynamic force produced or generated by the lifting force of the device; at least one defined beam connects the fore edge to the aft edge of the panel or panels; these edges are adjacent each panel(s) lateral end and/or adjacent to the fins; this device shall be equipped with elements capable to filter and/or block UV rays, and such elements shall be low weight, with appropriate dimensions and geometries that take advantage of the kinetic energy in the wind, which will provide strength to withstand aerodynamic forces caused by said fluid on the over the device (panel(s), beam(s), Fin(s), connection and anchorage elements) so the device during operation shall take a three-dimensional shape to provide a larger inertial moment of its structure, which at the same time allows for greater structural stability that facilitates lifting effect, preferably maintained at a certain height for most of the time, sufficiently off ground to enabling it to cast a shade and so users can move or stay securely between the ground and ceiling provided by the shade generating device.

2. Flexible shadow-generating wind-energy device, according to claim 1, wherein the panel or panels are preferably of trapezoidal configuration and can also be trapezoid, deltoid, rectangular, square, conical or other geometry favoring generation of adequate sustaining forces, with its fore and aft edges which may be straight, but preferably curved describing an outward concavity or convexity, and its lateral edges forming an angle of incidence between them and/or with the longitudinal axis, and a greater distance in the fore edge than the aft edge;

3. Flexible shadow-generating wind-energy device, according to claim 1, wherein each fin has one or more fasteners and preferably has a triangular shape, may also be in some sort of trapezoid or other polygonal or conical shape or combination thereof that favors adequate stability, using the inner edge of each adjacent fin to a corresponding panel and/or beam, and their outer edges which may be straight, but preferably curvilinear describing an outward concavity.

4. Flexible shadow-generating wind-energy device, according to claim 3 wherein the device has three fins distributed as follows; two lateral fins adjacent to the panel lateral edges, and an aft fin at the back of the device.

5. Flexible shadow-generating wind-energy device, according to claim 4 wherein the device may have only lateral fins and no stern fin.

6. Flexible shadow-generating wind-energy device according to claim 3 wherein the device may have fins on some or all of the interior beams.

7. Flexible shadow-generating wind-energy device according to claim 1 wherein the beams are preferably semi-open flexible tubular bodies having at least one of its ends open and this is located near the fore edge, and wherein the beams extend from fore to stern, preferably the beams are joined adjacently to each other towards the lateral axis together form a panel where the end beams on each side join adjacent edges of the fins.

8. Flexible shadow-generating wind-energy device according to claim 7, wherein the beams can be replaced wholly or partially by rods.

9. Flexible shadow-generating wind-energy device according to claim 7, wherein the beams are closed at both ends, forming an airtight chamber that allows confining gas under pressure within.

10. Device according to claim 7, wherein the device can have two or more beam wherein between the beams may be a space not occupied by beams; in such arrangement there are one or more panels in which the beams are connected, and the lateral edges of the panel are connected with at least one fin in each edge.

11. Device according to claim 7 wherein the flexible tubular beam(s) may be open at the fore edge and closed at the aft edge.

12. Device according to claim 7 wherein the flexible tubular beam(s) may have holes or a set of holes in some point in its structure to increase stability thereof and/or to support the device.

13. Device according to claim 7 wherein the beam or beams take along its entire length to become an aerodynamic profile in order to provide a lifting force to the flexible shadow-generating wind-energy device.

14. (canceled)

15. (canceled)

16. Device according to claim 7, where the longitudinal axes of each beam are parallel or at an angle between themselves and/or with the longitudinal axis.

17. Device according to claim 7, wherein the cross section of the beams is preferably rectangular, but may be of other geometric shape.

18. (canceled)

19. (canceled)

20. (canceled)

21. Device according to claim 1, wherein the device is anchored to the ground by fasteners and connecting elements, sufficient to keep the device off the ground for proper function.

22. (canceled)

23. Device according to claim 21, wherein the connecting elements are preferably flexible lines as strings, cords, threads, among others; the connecting elements can also be rigid or semi-rigid elements.

24. Device according to claim 1, wherein the massive bodies function as anchoring elements, and its position on the ground is movable.

25. Device according to claim 1, wherein the angle of attack formed between the panel(s) regarding wind direction, is preferably greater or equal than zero.

26. Device according to claim 7, wherein the fore edges of the beams' open end have an angle of attack greater than zero degrees regarding wind direction.
